(19) United States
(12) Patent Application Publication
(10) Pub. No.: US 2016/0062594 A1
(43) Pub. Date: Mar. 3, 2016

(54) Boundary Limits on Directional Selection Commands

(71) Applicant: Microsoft Corporation, Redmond, WA (US)

(72) Inventor: Michael Niksa, Redmond, WA (US)

(21) Appl. No.: 14/472,443

(22) Filed: Aug. 29, 2014

(51) Int. Cl. G06F 3/0481; G06F 3/0484

(52) U.S. Cl. CPC G06F 3/04812; G06F 3/0484

(57) ABSTRACT

A user interface for a computer processes a directional selection command for selecting display data between a start cursor location and an end cursor location. Given a current end cursor location in the display data, a boundary in the display data of content which contains the current end cursor location is identified. When selecting display data in response to a directional selection command, the computer searches within the display data in the designated direction from a current end cursor location for a next instance of a pattern in the display data. The pattern depends on the command. If the identified boundary is reached before the next instance of the designated pattern, then the current end cursor location is moved to the identified boundary.

### BACKGROUND

Most user interfaces on computers allow a user to select a range of displayed text using keyboard commands. Some of these keyboard commands allow the user to select, or expand a selection of, text in a direction from a current location in the text. For example, some commands allow a user to select, or to expand a selection of, text by selecting text between a start cursor location and an end cursor location, where the end cursor location is defined by a previous line, paragraph or page or a beginning of a line, paragraph or page.

### SUMMARY

This Summary is provided to introduce a selection of concepts in a simplified form that are further described below in the Detailed Description. This Summary is intended neither to identify key or essential features, nor to limit the scope, of the claimed subject matter.

A user interface for a computer processes a directional selection command for selecting display data between a start cursor location and an end cursor location. Given a current end cursor location in the display data, a boundary in the display data of content which contains the current end cursor location is identified.

Such a boundary can be related to a source from which the content originates, memory from which the content originates, or metadata about the content. Such metadata about the content can be metadata about the display data or can be metadata from the source or memory from which the content originates.

When selecting display data in response to a directional selection command, the computer searches within the display data in the designated direction from a current end cursor location for a next instance of a pattern in the display data. The pattern depends on the command. If the identified boundary is reached before the next instance of the designated pattern, then the current end cursor location is moved to the identified boundary.

In the following description, reference is made to the accompanying drawings which form a part hereof, and in which are shown, by way of illustration, specific example implementations. It is understood that other implementations with structural and functional changes from the described example implementations may be made without departing from the scope of the disclosure.

### DESCRIPTION OF THE DRAWINGS

FIG. 1 is an illustrative diagram of a graphical user interface in which content can be selected using a directional selection command.

FIG. 2 is a data flow diagram describing an example implementation of an application that processes directional selection commands.

FIG. 3 is a data flow diagram describing an example implementation of an output module that processes directional selection commands.

FIG. 4 is a flow chart describing an example implementation of processing a directional selection command.

FIG. 5 is a block diagram of an example computer with which a user interface supporting directional selection commands can be implemented.

### DETAILED DESCRIPTION

The following section describes an example implementation of a computer that processes directional selection commands.

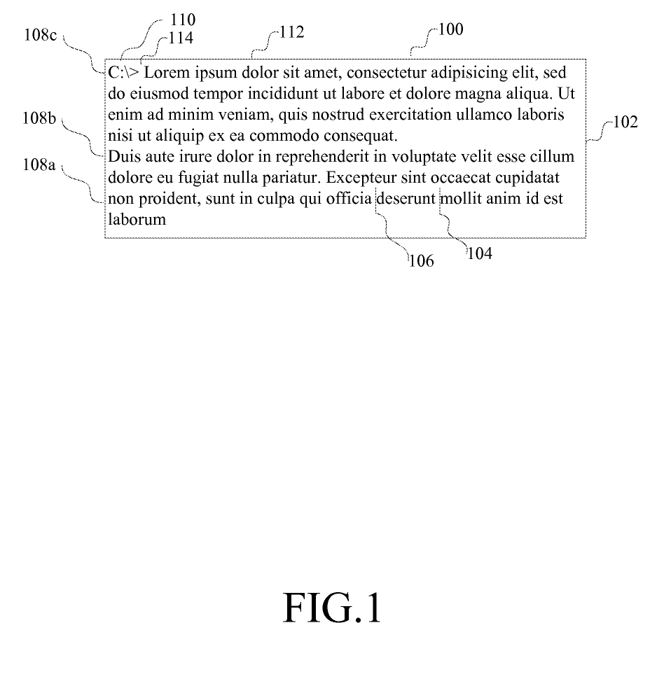

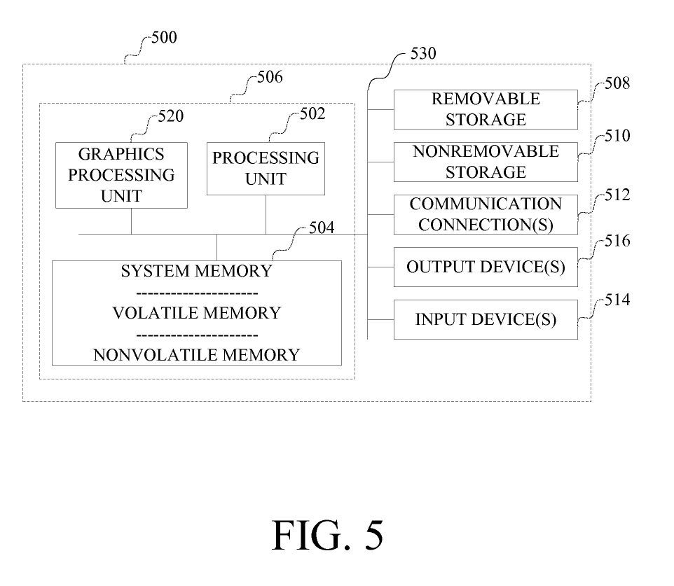

Referring to FIG. 1, an illustrative, graphical example of selection of display data will now be described. In this example, the display data shown is text, but display data can be any combination of media that can be combined and displayed on a display connected to a computer. In FIG. 1, display data 102, shown here as text, is communicated to a user via a display area 100 on a display connected to a computer, such as a computer described below in connection with FIG. 5. A start cursor location 104 indicates a location from which text selection can begin. The start cursor location can be set in any of a number of ways. An end cursor location 106, in combination with the start cursor location 104, defines a range in the text for selecting from the text. In particular, the computer selects text between the start cursor location and an end cursor location. In FIG. 1, the end cursor location 106 is shown separately from the start cursor location 104; however, the end cursor location and the start cursor location can be the same before any selection command is entered. Given a selection of the display data, a variety of content manipulation commands can be performed, usually in response to additional user input, such as copying, deleting, moving or other commands to manipulate the selected display data.

Given a start cursor location 104 and an initial end cursor location with respect to the display data, selection can occur by the computer receiving an input indicating a selection command. A selection command can be absolute, by indicating a location in the display data; a selection command can be directional, by indicating a direction with respect to at least the current end cursor location. The result of a directional selection command is to move at least the current end cursor location to a new end cursor location in the indicated direction. The end cursor location is determined based on a search in the display data from the current end cursor location in the indicated direction for a particular pattern. A pattern generally is one or more characters in the display data, whether visible or hidden, and/or parameters of a display buffer storing the display data, e.g., line breaks and buffer size, for example. In some cases, a directional content selection command can also result in changing the start cursor location.

Directional selection commands generally are based on a keyboard or similar input, in contrast to a pointer device that generally inputs a specific location. Because the command is directional, and not a location, the computer performs a search within the display data, in the designated direction, for the pattern associated with the particular command. In addition to keyboard input, such directional selection commands also can originate from gesture input, speech input, or any other input that is programmed to correspond to a direction and pattern.

There are many different implementations of specific directional selection commands, which vary based on inputs used to invoke the command, patterns within display data for which searching occurs, and resulting end cursor location. For example, the inputs can include any combination of one or more keystrokes including one or more keys on a keyboard. The pattern searched for can be, for example, a single hidden character, such as a line break, or paragraph marker or page break, or a combination of characters, or even an input string provided by a user. The end cursor location may be, for example, before or after the matched pattern in the searched display data. For the purposes of illustration only, this document uses a limited number of examples; such examples should not be understood as limiting the range of directional selection commands to which the described example implementation of a computer system can apply.

As shown in FIG. 1, one example of a directional selection command is a command to move the end cursor location to the beginning of the line, as shown at 108a. Another example of a directional selection command is a command to move the end cursor location to the beginning of the paragraph, as shown at 108b. Yet another example of a directional selection command is a command to move the end cursor location to the beginning of the page, as shown at 108c.

Other examples of directional selection commands move the end cursor location to a previous or following character, the beginning or end of a previous word or a following word, an end of a line, paragraph or page, the same location in a previous or subsequent line, paragraph or page, a previous or subsequent instance of a string, and so on. Some directional selection commands move both the start and the end cursor locations, such as a command that selects an entire line, paragraph, section, page or document.

In the example of FIG. 1, the display area 100 includes display data 102 that originates from two different sources. In this example, a prompt 110 (e.g., “C:\>”) is an output generated by an application executed on a computer. The remaining content, input text 112, is an output generated based on data in an input buffer that is being edited by a user through the application. So, in this example, the input text is dynamic, because it can change by being edited by a user, while the prompt 110 is static, because it is generated by the application and cannot be edited by the user. In this example, the application maintains data defining the prompt 110 in a first buffer, and maintains data defining the input text 112 in a second buffer. The application combines the contents of the first and second buffers into the display data in a display buffer which is accessed by a display. Such an interface is commonly provided in applications that provide command line interfaces. As an alternative example, the application can generate display data using content originating from multiple sources, such as two different data files, a data buffer and a data file, and so on.

Thus, the display data from which an actual output for an application on a display is derived generally is stored in a memory location, typically called a display buffer, distinct from the data source used to generate the display data. This display buffer generally has parameters associated with it, such as dimensions, cursor locations, and other properties.

The start and end cursor locations for selecting display data are defined with reference to the display data, i.e., locations in the display data or display buffer. Searching for directional selection commands is performed with reference to the display data. To provide an intuitive user experience, an extent of searching performed in the display data in response to a directional selection command is limited based on one or more boundaries in the display data of content which contains a current cursor location. For example, given a current end cursor location in the displayed data, an application identifies a boundary in the display data of content which contains the current end cursor location.

Such a boundary can be related to a source from which the content originates, memory from which the content originates, or metadata about the content. Such metadata about the content can be metadata about the display data or can be metadata from the source or memory from which the content originates.

For example, if the display data in which selection occurs originates from two different buffers in memory, the identified boundary can be the based on the boundaries in the display data of the buffer that provided the content which contains the current end cursor location. As another example, if the display data in which selection occurs originates from two different files, the identified boundary can be based on the boundaries in the display data of the file that provided the content which contains the current end cursor location. As another example, if attributes of characters in the display data indicate a significant change, such as a change in color, a boundary can be defined by such changes. As another example, if source data in a buffer or data source is being accessed to generate the display data, metadata about the source data can define a boundary.

Thus, as an illustrative example, in FIG. 1, the boundary 114 of the input text 112 within the display data is identified, and the scope of any directional selection command is initially limited to moving the end cursor location within the boundary of that input text.

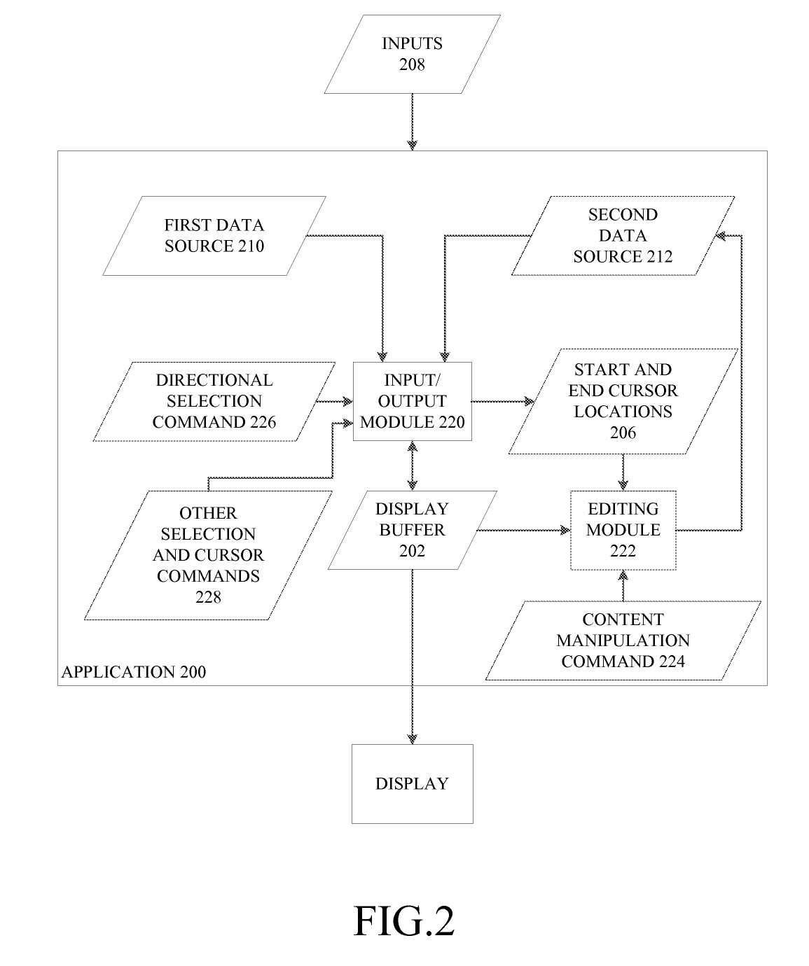

Referring now to FIG. 2, a block diagram of an example application running on a computer which implements such directional selection commands will now be described. An application 200 can include a display buffer 202 from which display data are read to be output on a display 204.

A display buffer can be implemented, for example, as an array of characters, in which each character can be represented using a character encoding, of which Unicode codes and ASCII codes are examples. Other information can be associated with the display buffer. Display buffer attributes can include cursor locations, other cursor properties, display area size, and the like. There may also be metadata about the display data, such as attributes of each character, including but not limited to foreground and background colors.

An application can receive inputs 208, such as from various input devices (not shown). In general, the inputs 208 are provided from input devices through an operating system (not shown). Directional selection commands are one kind of command that can result from inputs 208, as is input text which may be placed in the input buffer by the application. Other selection and cursor commands 228 and content manipulation commands also may result from inputs 208. Selection and cursor commands may alter the start and end cursor locations before and/or after such cursor locations are set using a directional selection command.

The application has an input/output module 220 which generates the display data in the display buffer 202, often from at least two sources. In the example in FIG. 2, the display data in the display buffer are generated from a first data source 210 (e.g., an output buffer for an application generated prompt) and a second data source 212 (e.g., an input buffer for user input text). Such sources also can be data files from storage or data structures in memory, and the like. Such sources also may have associated metadata, whether about the source or about data in the source.

The input/output module 220 also can select display data in the display buffer in response to a directional selection command 226 by providing start and end cursor locations 206. Any such selection of display data can be indicated within the display buffer. For the purposes of illustration, the input/output module 220 is shown as having access to the data sources 210 and 212 (e.g., output buffer and input buffer), used to generate the display data in the display buffer 202, to determine and provide the start and end cursor locations 206. This input/output module can receive a directional selection command 226, or other commands 228, to manipulate start and end cursor locations 206. Boundaries in the display data, corresponding to content originating from the different data sources 210 and 212, limit the directional selection commands 226.

An editing module 222 can use the data in the display buffer 202, and the start and end cursor locations 206, to perform a variety of operations that manipulate the display data, in response to content manipulation commands 224. Examples of content manipulation commands include, but are not limited to, such as copy, cut, paste, and so on. In this example application, such content manipulation commands modify data in an input buffer.

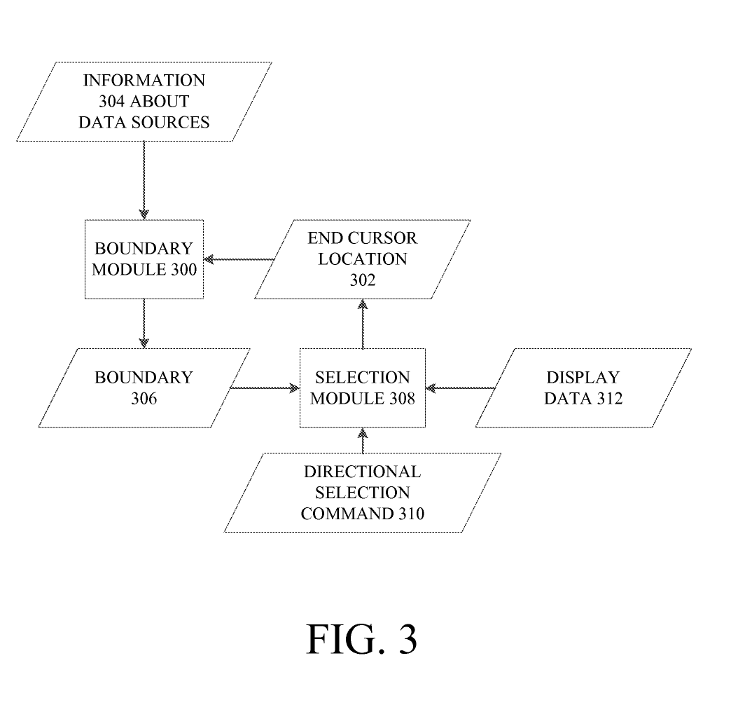

A more detailed data flow diagram for an example implementation of the input/output module 220 will now be described in connection with FIG. 3. This implementation describes using boundaries based on the data sources. In FIG. 3, a boundary module 300 receives at least an end cursor location 302 and information 304 about data sources, to identify a boundary 306 in the display data of content which contains the current end cursor location. As an example implementation, an object representing the display buffer can have an associated method that, given a cursor location, returns boundaries within the display data corresponding to the data source which provides the content containing the cursor location. As another example, an object representing the display buffer can have an associated method that returns the boundaries within the display data corresponding to the data sources providing the content to the display buffer. Similarly, a data structure can track boundaries within the display data corresponding to the data sources providing the content to the display buffer. One or more boundaries are provided to the selection module 308, which performs a designated directional selection command 310 on display data 312, in turn updating the end cursor location 302.

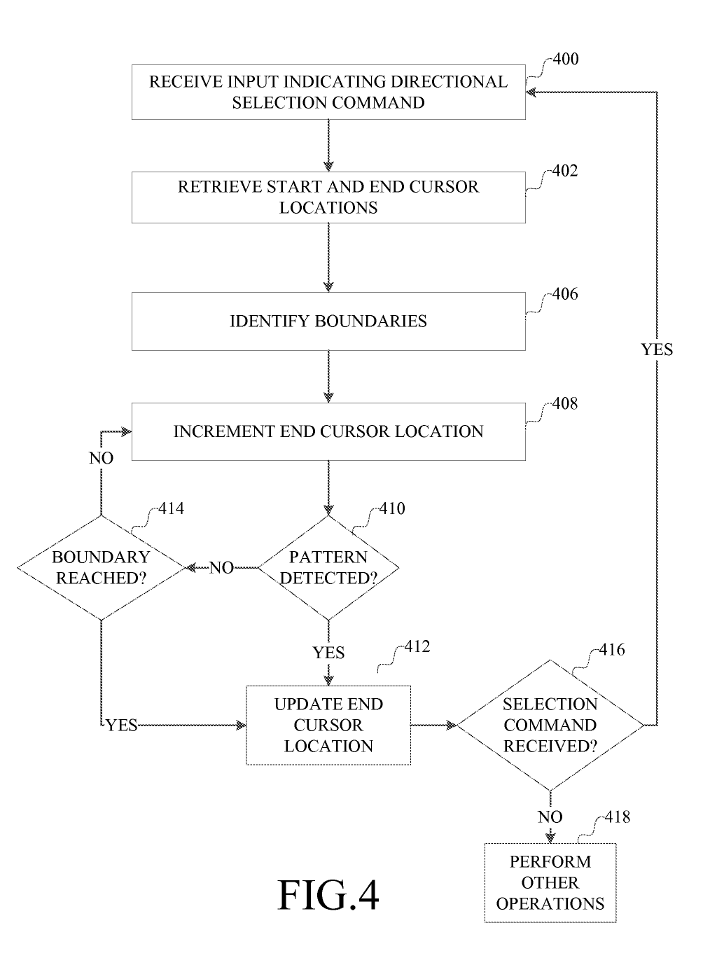

A flowchart of an example implementation for an application to perform such a directional selection command shown in FIG. 3 will now be described in connection with FIG. 4. The application receives 400 an input indicating a directional selection command. The directional selection command may be received with data defining a start cursor location and an end cursor location. Otherwise, the start cursor location and end cursor location are retrieved 402. If the command is received with display data already selected, then the start cursor location and end cursor location are different. If the command is received with no display data selected yet, the start cursor location and end cursor location for the command may be initialized to a current cursor location.

Using the current start and/or end cursor location(s), the application identifies 406 one or more data boundaries. In particular, a location in the display data of a beginning or end, or both, of content originating from one of the data sources is identified. This operation can be performed in many ways, such as described above in connection with FIG. 3. Note that if the returned boundary is the same as the cursor location, then the boundary corresponding to the adjacent data source in the direction of the directional command is the boundary that is used.

The application then searches in the display data for the pattern, and in the direction, specified by the command, and stops searching at the first occurrence of either the pattern or the identified boundary if that boundary is reached first. In particular, the current end cursor location is incremented 408. If the pattern is detected as indicated at 410, then the updated end cursor location is returned 412 and the user interface can be refreshed to show the selected display data. Otherwise, if the boundary has been reached, as indicated at 414, then the updated end cursor location is returned 412 and the user interface can be refreshed to show the selected display data. The end cursor location is otherwise incremented 408 until either the pattern is detected or the boundary is reached, providing an updated end cursor location and refreshing the user interface.

It is possible that directional selection commands are repeatedly entered by a user. If another command is entered, as indicated at 416, the processing of FIG. 4 can repeat for the next command. Alternatively, the computer can perform other operations in response to other user inputs as indicated at 418. For example, given the selected display data, a content operation command, such as copy, paste, delete and the like, can be performed.

Variations of the example implementations of FIG. 3 and FIG. 4 can be made by using other data to define boundaries. In addition to the boundaries in the display data of the content from different sources, metadata from or about the different sources, and/or metadata about the display data originating from those sources also can be used to define boundaries. Metadata from the source can include markup data within the source, for example. The metadata about the display data includes attributes of characters to be displayed such as text color (whether foreground or background), text style, text font, text size, inverse rendering directives, and the like. Such metadata may be stored as matched to each character position of the display data. By accessing metadata external to the display data and the display buffer, various boundaries can be defined. For example, a boundary can be defined based on changes in color, changes in font size, or changes in markup style or category within the data source.

With such an implementation of boundary limited directional selection commands, the application will provide a more intuitive response to a directional selection command. The more intuitive response results in fewer keystrokes being made by the user to select display data, and perform a content manipulation command using the selected display data, thus improving user productivity.

Accordingly, in one aspect, a computer receives a directional selection command with respect to display data to be communicated on a display, the directional selection command being associated with a pattern and a direction to search, from an end cursor location, for the pattern in the display data. The computer identifies a boundary in the display data of content which contains a current end cursor location. The computer identifies a first occurrence, in the direction in the display data, of one of the boundary or the pattern. The computer sets the end cursor location to the location of this first occurrence.

In one aspect, a computer includes a means for determining, in response to a directional selection command, a boundary in the display data of content which contains a current end cursor location, and means for identifying a first occurrence, in the display data, of either the boundary or the pattern as an updated end cursor location.

In another aspect, a computer includes a boundary detector that receives a cursor location in display data, and provides a boundary in the display data of content which contains the cursor location. A selector limits setting the cursor location resulting from a directional selection command to a cursor location in the display data within the boundary.

In another aspect, a computer receives a directional selection command with respect to display data to be communicated on a display, the directional selection command being associated with a pattern and a direction to search for the pattern in the display data, the directional selection command having a start cursor location and an end cursor location. The computer displays selected display data on the display, the selected display data being defined by the start cursor location and an updated end cursor location. The updated end cursor location corresponds to a first occurrence, in the direction in the display data, of one of a boundary in the display data of content which contains the end cursor location and the pattern.

In another aspect, a computer includes a means for displaying, in response to a directional selection command associated with a pattern and a direction, selected display data. The selected display data is defined by a start cursor location and an updated end cursor location. The updated end cursor location corresponds to a first occurrence, in the direction in the display data, of one of a boundary in the display data of content which contains the end cursor location and the pattern.

In another aspect, a computer includes a selector that selects display data, in response to a directional selection command associated with a pattern and a direction. The selected display data is defined by a start cursor location and an updated end cursor location. The updated end cursor location corresponds to a first occurrence, in the direction in the display data, of one of a boundary in the display data of content which contains the end cursor location and a pattern.

Any of the foregoing and following aspects may be embodied as one or more computers, as any individual component of such a computer, as a process performed by one or more computers or any individual component of such a computer, or as an article of manufacture including computer storage with computer program instructions are stored and which, when processed by one or more computers, configure the one or more computers to provide such a computer or any individual component of such a computer.

In any of the foregoing aspects, the computer can repeat identifying the boundary, identifying the first occurrence of the boundary or pattern and setting the end cursor location, in response to receiving an additional directional selection command.

In any of the foregoing aspects, the computer can highlight selected display data on the display between the start cursor location and the end cursor location.

In any of the foregoing aspects, the computer can receive a content manipulation command and applying the content manipulation command to selected display data between the start cursor location and the end cursor location.

In any of the foregoing aspects, the display data communicated in the display can be a command line interface for entering commands of an operating system.

In any of the foregoing aspects, the display data to be communicated on the display originates from data from a first buffer and data from a second buffer. The computer can identify a boundary by determining whether the end cursor location is associated with the data from the first buffer or the second buffer, and then setting the boundary to be a location in display data that corresponds to an end of data from the first buffer or the second buffer.

In any of the foregoing aspects, the computer can identify a boundary by determining whether the end cursor location is associated with data from a first source or a second source, and then setting the boundary to be a location in the display data that corresponds to an end of the data from the first source or the second source.

In any of the foregoing aspects, the computer can identify a boundary by determining whether the end cursor location is associated with metadata about the display data, and setting the boundary to be a location in the display data that corresponds to such metadata. The metadata about the display data can include metadata associated with characters in the display data. The metadata about the display data can include metadata from a data source from which the display data is derived.

FIG. 5 illustrates an example computer with which the various components of the system of FIGS. 1-4 can be implemented. The computer can be any of a variety of general purpose or special purpose computing hardware configurations. Some examples of types of computers that can be used include, but are not limited to, personal computers, game consoles, set top boxes, hand-held or laptop devices (for example, media players, notebook computers, tablet computers, cellular phones, personal data assistants, voice recorders), server computers, multiprocessor systems, microprocessor-based systems, programmable consumer electronics, network PCs, minicomputers, mainframe computers, and distributed computing environments that include any of the above types of computers or devices, and the like.

With reference to FIG. 5, an example computer 500 includes at least one processing unit 502 and memory 504. The computer can have multiple processing units 502. A processing unit 502 can include one or more processing cores (not shown) that operate independently of each other. Additional co-processing units, such as graphics processing unit 520, also can be present in the computer. The memory 504 may be volatile (such as dynamic random access memory (DRAM) or other random access memory device), non-volatile (such as a read-only memory, flash memory, and the like) or some combination of the two. This configuration of memory is illustrated in FIG. 5 by dashed line 506. The computer 500 may include additional storage (removable and/or non-removable) including, but not limited to, magnetically-recorded or optically-recorded disks or tape. Such additional storage is illustrated in FIG. 5 by removable storage 508 and non-removable storage 510. The various components in FIG. 5 are generally interconnected by an interconnection mechanism, such as one or more buses 530.

A computer storage medium is any medium in which data can be stored in and retrieved from addressable physical storage locations by the computer. Computer storage media includes volatile and nonvolatile memory, and removable and non-removable storage media. Memory 504 and 506, removable storage 508 and non-removable storage 510 are all examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage media and communication media are mutually exclusive categories of media.

Computer 500 may also include communications connection(s) 512 that allow the computer to communicate with other devices over a communication medium. Communication media typically transmit computer program instructions, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media. Communications connections 512 are devices, such as a network interface or radio transmitter, that interface with the communication media to transmit data over and receive data from communication media.

Computer 500 may have various input device(s) 514 such as a keyboard, mouse, pen, camera, touch input device, and so on. Output device(s) 516 such as a display, speakers, a printer, and so on may also be included. All of these devices are well known in the art and need not be discussed at length here. The input and output devices can be part of a housing that contains the various components of the computer in FIG. 5, or can be separable from that housing and connected to the computer through various connection interfaces, such as a serial bus, wireless communication connection and the like. Various input and output devices can implement a natural user interface (NUI), which is any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, gesture recognition both on screen and adjacent to the screen, air gestures, head and eye tracking, voice and speech, vision, touch, gestures, and machine intelligence, and may include the use of touch sensitive displays, voice and speech recognition, intention and goal understanding, motion gesture detection using depth cameras (such as stereoscopic camera systems, infrared camera systems, and other camera systems and combinations of these), motion gesture detection using accelerometers or gyroscopes, facial recognition, three dimensional displays, head, eye, and gaze tracking, immersive augmented reality and virtual reality systems, all of which provide a more natural interface, as well as technologies for sensing brain activity using electric field sensing electrodes (EEG and related methods).

The various storage 510, communication connections 512, output devices 516 and input devices 514 can be integrated within a housing with the rest of the computer, or can be connected through input/output interface devices on the computer, in which case the reference numbers 510, 512, 514 and 516 can indicate either the interface for connection to a device or the device itself as the case may be.

Each component (which also may be called a “module” or “engine” or the like), of a system such as described in FIGS. 1-4 above, and which operates on a computer, can be implemented using the one or more processing units of one or more computers and one or more computer programs processed by the one or more processing units. A computer program includes computer-executable instructions and/or computer-interpreted instructions, such as program modules, which instructions are processed by one or more processing units in the one or more computers. Generally, such instructions define routines, programs, objects, components, data structures, and so on, that, when processed by a processing unit, instruct the processing unit to perform operations on data or configure the processor or computer to implement various components or data structures. Such components have inputs and outputs by accessing data in storage or memory and storing data in storage or memory.

This computer system may be practiced in distributed computing environments where operations are performed by multiple computers that are linked through a communications network. In a distributed computing environment, computer programs may be located in both local and remote computer storage media.

Alternatively, or in addition, the functionality of one or more of the various components described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The terms “article of manufacture”, “process”, “machine” and “composition of matter” in the preambles of the appended claims are intended to limit the claims to subject matter deemed to fall within the scope of patentable subject matter defined by the use of these terms in 35 U.S.C. §101.

It should be understood that the subject matter defined in the appended claims is not necessarily limited to the specific implementations described above. The specific implementations described above are disclosed as examples only.

What is claimed is:

1. A computer-implemented process for processing directional selection commands for a user interface, comprising:
receiving a directional selection command with respect to display data to be communicated on a display, the directional selection command being associated with a pattern and a direction to search, from an end cursor location, for the pattern in the display data;
identifying a boundary in the display data of content which contains the end cursor location;
identifying a first occurrence, in the direction in the display data, of one of the boundary or the pattern; and
setting the end cursor location to the identified position.

2. The computer-implemented process of claim 1, further comprising:
repeating the identifying the boundary, identifying the first occurrence of the boundary or pattern, and setting the end cursor location in response to receiving an additional directional selection command.

3. The computer-implemented process of claim 1, further comprising highlighting selected display data on the display between the start cursor location and the end cursor location.

4. The computer-implemented process of claim 1, further comprising receiving a content manipulation command and applying the content manipulation command to selected display data between the start cursor location and the end cursor location.

5. The computer-implemented process of claim 1, wherein the display data communicated in the display is a command line interface for entering commands of an operating system.

6. The computer-implemented process of claim 1, wherein the display data to be communicated on the display originates from data from a first buffer and data from a second buffer, and wherein identifying a boundary comprises:
determining whether the end cursor location is associated with the data from the first buffer or the second buffer;
setting the boundary to be a location in the display data that corresponds to an end of the data from the first buffer or the second buffer.

7. The computer-implemented process of claim 1, wherein identifying a boundary comprises:
determining whether the end cursor location is associated with data from a first source or a second source;
setting the boundary to be a position in the display data that corresponds to an end of data from the first source or the second source.

8. An article of manufacture, comprising:
computer storage comprising at least one of a memory device and a storage device;
computer program instructions stored on the computer storage that, when processed by a computer, instruct the computer to perform a computer-implemented process for processing directional selection commands for a user interface, comprising:
receiving a directional selection command with respect to display data to be communicated on a display, the directional selection command being associated with a pattern and a direction to search, from an end cursor location, for the pattern in the display data;
identifying a boundary in the display data of content which contains the end cursor location;
identifying a first occurrence, in the direction in the display data, of one of the boundary or the pattern; and
setting the end cursor location to the identified position.

9. The article of manufacture of claim 8, wherein the process performed by the computer further comprises:
repeating the identifying the boundary, identifying the first occurrence of the boundary or pattern, and setting the end cursor location in response to receiving an additional directional selection command.

10. The article of manufacture of claim 8, wherein the process performed by the computer further comprises highlighting selected display data on the display between the start cursor location and the end cursor location.

11. The article of manufacture of claim 8, wherein the process performed by the computer further comprises receiving a content manipulation command and applying the content manipulation command to selected display data between the start cursor location and the end cursor location.

12. The article of manufacture of claim 8, wherein the display data is a command line interface for entering commands of an operating system.

13. The article of manufacture of claim 8, wherein the display data originates from data from a first buffer and data from a second buffer, and wherein identifying a boundary comprises:
determining whether the end cursor location is associated with data from the first buffer or the second buffer;
setting the boundary to be a location in the display data that corresponds to an end of data from the first buffer or the second buffer.

14. The article of manufacture of claim 8, wherein identifying a boundary comprises:
determining whether the end cursor location is associated with data from a first source or a second source;
setting the boundary to be a location in the display data that corresponds to an end of data from the first source or the second source.

15. A computer system, comprising:
one or more processing units;
computer storage accessible by the one or more processing units;
the computer storage including computer program code for an application that, when processed by the one or more processing units instructs the one or more processing units to perform a process comprising:
receiving a directional selection command with respect to display data to be communicated on a display, the directional selection command being associated with a pattern and a direction to search, from an end cursor location, for the pattern in the display data;
displaying selected display data on the display, the selected display data being defined by at least the end cursor location, the end cursor location corresponding to a first occurrence, in the direction in the display data, of one of a boundary in the display data of content which contains the end cursor location of the pattern.

16. The computer system of claim 15, wherein the process performed by the one or more processing units further comprises:
repeating the displaying of the selected display data in response to an additional directional selection command.

17. The computer system of claim 15, wherein the process performed by the one or more processing units further comprises highlighting selected display data on the display between the cursor location and the end cursor location.

18. The computer system of claim 15, wherein the display data is a command line interface for entering commands of an operating system.

19. The computer system of claim 15, wherein the display data originates from data from a first buffer and data from a second buffer, and wherein identifying a boundary comprises:
determining whether the end cursor location is associated with data from the first buffer or the second buffer;
setting the boundary to be a location in the display data that corresponds to an end of data from the first buffer or the second buffer.

20. The computer system of claim 15, wherein identifying a boundary comprises:
determining whether the end cursor location is associated with data from a first source or a second source;
setting the boundary to be a location in the display data that corresponds to an end of data from the first source or the second source.
